(19) United States
(12) Patent Application Publication
(10) Pub. No.: US 2004/0168379 A1
(43) Pub. Date: Sep. 2, 2004

(54) Screen door having screen retaining structure

(76) Inventor: Chang Than Chen, Kaohsiung (TW)

Correspondence Address: CHARLES E. BAXLEY, ESQUIRE, Fifth Floor, 59 John Street, New York, NY, 10038, US

(21) Appl. No.: 10/376,648

(22) Filed: Feb. 27, 2003

(51) Int. Cl. E06B 3/28; E06B 3/26

(52) U.S. Cl. 52/202; 52/203

(57) ABSTRACT

A screen door includes two stiles and two beams secured together to form a rectangular frame, and to define an opening within the frame, and a screen received in the opening of the frame. The stiles and the beams each may include one or more longitudinal groove to receive a spline which may force and engage the screen into the longitudinal groove of the stiles and the beams. The stiles and the beams each may include one or more longitudinal flanges extended into the longitudinal grooves and to retain the spline and the screen within the longitudinal grooves of the stiles and the beams, and to solidly secure the screen to the frame.

### BACKGROUND OF THE INVENTION

1. Field of the Invention

The present invention relates to a screen door, and more particularly to a screen door having a solid configuration and having a structure for solidly retaining screen therein.

2. Description of the Prior Art

Various kinds of typical screen doors have been developed and comprise a screen member attached to a doorframe. The doorframe may be made of aluminum materials, foamable materials, rubber materials, or the other typical synthetic materials. The screen member is typical secured to the doorframe with nails, splines, ribs or the like.

For example, U.S. Pat. No. 6,250,040 to Green discloses one of the typical screen doors comprise two rails and two stiles to be connected together to form a rectangular frame, by such as dowels, adhesives, screws and traditional mortise and tenon joints.

However, the door frames, particularly the ends or corners of the door frames may include a weak structure when the door frames are made of foamable materials, rubber materials, or the other typical synthetic materials, and may thus be easily broken or damaged due to the weak coupling or connection by the dowels, screws and traditional mortise and tenon joints.

In addition, it takes time for the adhesives applied between the rails and the stiles to be solidly secured together, and it should wait until the adhesives are cured and wait until the rails and the stiles to be solidly secured together.

Furthermore, the screen is secured to the door frame with rubber splines or rails, by engage both the screen and the rubber splines or rails into grooves of the door frame. However, the rubber splines or rails and the screen may not be solidly secured to the door frame, and may be easily separated or disengaged from the door frame, such that additional adhesive materials are required to be applied or engaged into the grooves of the door frame.

Similarly, it also takes time for the adhesives applied between the door frame and the splines and the screen to be solidly secured together, and it should wait until the adhesives are cured and wait until the door frame and the splines and the screen to be solidly secured together, such that it takes a long time before the screen door may be formed or manufactured. The screen may have a good chance to be disengaged from the door frame after use.

The present invention has arisen to mitigate and/or obviate the afore-described disadvantages of the conventional screen doors.

### SUMMARY OF THE INVENTION

The primary objective of the present invention is to provide a screen door including a solid configuration for allowing the screen door to be easily and quickly formed or assembled without dowels, screws or traditional mortise or tenon joints.

The other objective of the present invention is to provide a screen door including a structure for solidly retaining the screen in the doorframe.

In accordance with one aspect of the invention, there is provided a screen door comprising two stiles and two beams secured together to form a rectangular frame, and to define an opening within the frame, a screen received in the opening of the frame, the stiles and the beams each including at least one longitudinal groove formed therein, and at least one spline engaged onto the screen, to force and engage the screen into the longitudinal groove of the stiles and the beams respectively. The stiles and the beams each may include at least one longitudinal flange extended into the longitudinal groove thereof respectively, and to engage with and to solidly retain the spline and the screen within the longitudinal groove of the stiles and the beams, and to solidly secure the screen to the frame.

The screen door may be easily and quickly formed or solidly assembled without dowels, screws or traditional mortise or tenon joints. The stiles and the beams may be formed into various shapes and may be applied with various colors and/or shapes thereon, and may be cut or formed into various shapes or contours.

The stiles each may further include at least one tooth extended into the longitudinal groove thereof respectively, and to further engage with and to further retain the spline and the screen within the longitudinal groove of the stiles. It is preferable that the stiles each may include a number of teeth extended into the longitudinal groove thereof respectively.

The beams each may further include at least one tooth extended into the longitudinal groove thereof respectively, and to further engage with and to further retain the spline and the screen within the longitudinal groove of the beams. It is preferable that the beams each may include a number of teeth extended into the longitudinal groove thereof respectively.

Further objectives and advantages of the present invention will become apparent from a careful reading of the detailed description provided herein below, with appropriate reference to the accompanying drawings.

### BRIEF DESCRIPTION OF THE DRAWINGS

FIG. 1 is a perspective view of a screen door in accordance with the present invention, in which a screen has not been attached to the door frame of the screen door;

FIG. 2 is a partial front and exploded view of the screen door, showing the stile and the beam before securing together;

FIG. 3 is a partial upper and exploded view of the screen door, showing the stile and the beam before securing together;

FIG. 4 is an upper or end view of a stile of the screen door;

FIG. 5 is an enlarged partial upper or end view of the stile of the screen door;

FIG. 6 is a cross sectional view taken along lines 6-6 of FIG. 1;

FIG. 7 is a partial front view of the screen door, in which a screen has been shown to be attached to the door frame of the screen door;

FIG. 8 is a partial cross sectional view taken along lines 8-8 of FIG. 7; and

FIG. 9 is an enlarged partial cross sectional view of that shown in FIG. 8.

### DETAILED DESCRIPTION OF THE PREFERRED EMBODIMENT

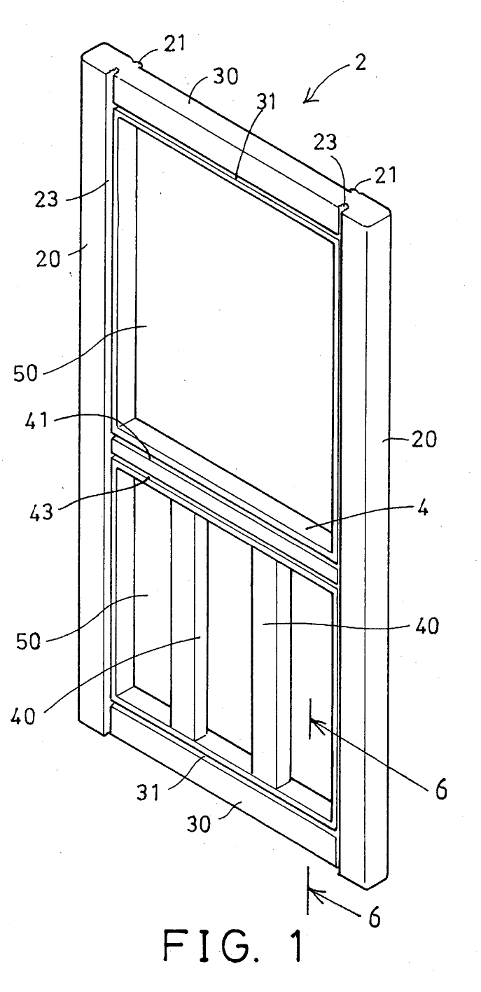

Referring to the drawings, and initially to FIGS. 1-6, a screen door in accordance with the present invention comprises a door frame 2 including two stiles 20 and two beams 30 to be secured together to form a rectangular frame, and to form or define an opening 50 within the frame 2, and including one or more bars 4 and posts 40 received in the opening 50 of the frame 2 and secured between the stiles 20 and the beams 30.

The stiles 20 and the beams 30 and/or the bars 4 and the posts 40 may be made of aluminum materials, foamable materials, rubber materials, or the other typical synthetic materials, but preferably made of foamable polyvinyl chloride (PVC) materials, wood chips or powders, and the other additives, such as foamable agents, stabilizers, etc., and may be formed by such as molding or mold-injection processes. It is preferable that the wood chips or powders comprise about 10-60% of the door frame by weight, and include a dimension or diameter of about 40-100 mesh, and include a specific weight of about 0.5-0.8 g/cm³.

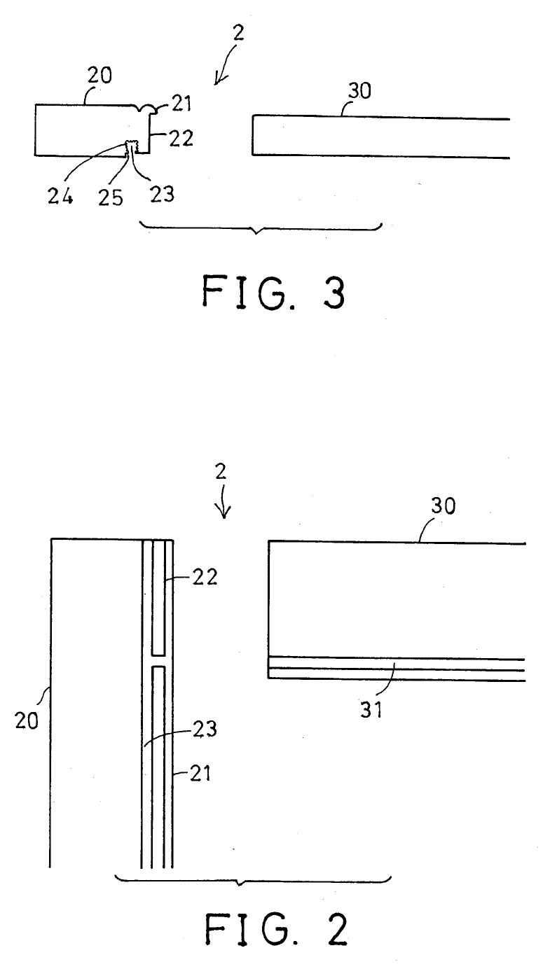

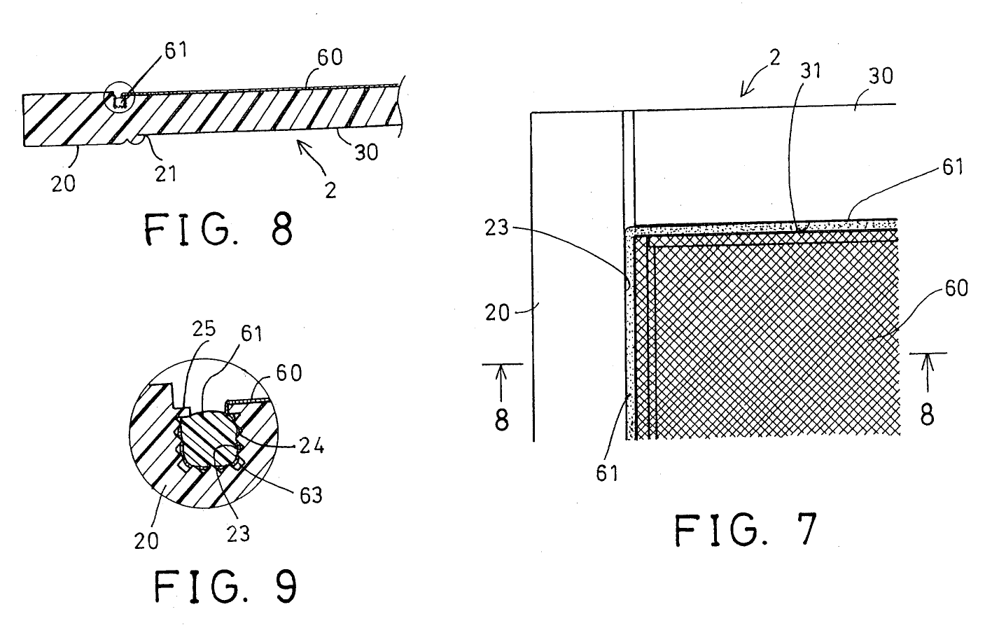

As shown in FIGS. 2-4, the stiles 20 each may include one flat side 22 having a longitudinal rib 21 extended outwardly therefrom. The beams 30 and/or the bars 4 each includes one end engaged onto the flat side 22 of the stiles 20, and solidly secured to the stiles 20 with heating processes, welding processes, or additional molding processes, or the like, in order to form a solid and integral frame 2 (FIGS. 1, 8). The posts 40 may also be solidly secured to the bars 4 and the beams 30 with heating processes, welding processes, or additional molding processes, or the like.

The stiles 20 and the beams 30 and/or the bars 4 each includes one or more longitudinal grooves 23, 31, 41, 43 (FIG. 1) formed therein and dimensioned to hold screen 60 and splines 61 (FIGS. 7-9), which may be provided to secure the screen 60 to the frame 2.

For example, as shown in FIGS. 3-6 and 8-9, the stiles 20 and the beams 30 and/or the bars 4 each includes one or two longitudinal flanges 25, 33 extended into the outer or open end of the grooves 23, 31, 41, 43 respectively thereof, to solidly retain the splines 61 and the screen 60 within the grooves 23, 31, 41, 43 thereof respectively; and each may further include one or more teeth 24, 32 extended into the grooves 23, 31, 41, 43 thereof respectively, and thus to further solidly retain the splines 61 and the screen 60 within the grooves 23, 31, 41, 43 thereof respectively.

In operation, as shown in FIGS. 7-9, the screen 60, particularly the outer peripheral portion 63 (FIG. 9) of the screen 60 may be forced and engaged into the grooves 23, 31, 41, 43 of the stiles 20 and the beams 30 and/or the bars 4 respectively by the splines 61, and the splines 61 and the screen 60 may then be solidly retained within the grooves 23, 31, 41, 43 of the stiles 20 and the beams 30 and/or the bars 4 respectively, in order to solidly secure the screen 60 to the frame 2.

The longitudinal flanges 25, 33 and/or the teeth 24, 32 of the stiles 20 and the beams 30 and/or the bars 4 may be used to solidly retain the splines 61 and the screen 60 in the grooves 23, 31, 41, 43 of the stiles 20 and the beams 30 and/or the bars 4 respectively. It is to be noted that the middle portion (not shown) of the screen 60 may be forced and engaged into the grooves 41, 43 of the bars 4 by the splines 61, and the splines 61 and the screen 60 may then be solidly retained within the grooves 41, 43 of the bars 4, in order to solidly secure the screen 60 to the bars 4.

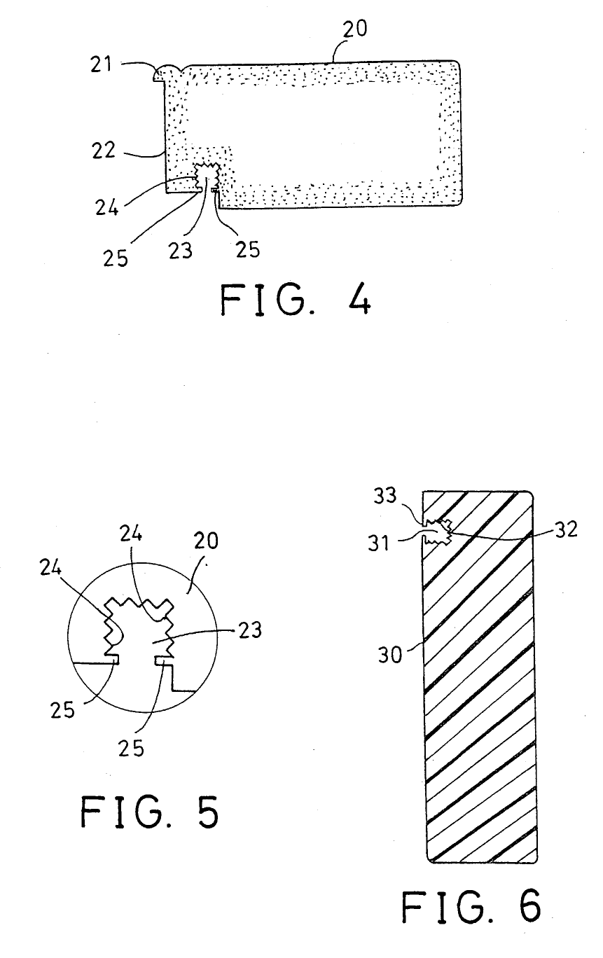

The stiles 20 and the beams 30 and/or the bars 4 may be formed or applied with various kinds of colors and/or patterns (FIG. 4), such as the wood-shaped colors or patterns, or the like, and may also be cut or shaped or trimmed into various shapes or contours for allowing the door frame 2 to be suitably attached to various walls, furniture, buildings, etc.

Accordingly, the screen door in accordance with the present invention includes a solid configuration for allowing the screen door to be easily and quickly formed or assembled without dowels, screws or traditional mortise or tenon joints, and includes a structure for solidly retaining the screen in the door frame.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A screen door comprising:
two stiles and two beams secured together to form a rectangular frame, and to define an opening within said frame,
a screen received in said opening of said frame,
said stiles and said beams each including at least one longitudinal groove formed therein,
at least one spline engaged onto said screen, to force and engage said screen into said at least one longitudinal groove of said stiles and said beams respectively,
said stiles and said beams each including at least one longitudinal flange extended into said at least one longitudinal groove thereof respectively, and to engage with and to solidly retain said at least one spline and said screen within said at least one longitudinal groove of said stiles and said beams, and to solidly secure said screen to said frame.

2. The screen door as claimed in claim 1, wherein said stiles each further includes at least one tooth extended into said at least one longitudinal groove thereof respectively, and to further engage with and to further retain said at least one spline and said screen within said at least one longitudinal groove of said stiles.

3. The screen door as claimed in claim 1, wherein said beams each further includes at least one tooth extended into said at least one longitudinal groove thereof respectively, and to further engage with and to further retain said at least one spline and said screen within said at least one longitudinal groove of said beams.

4. The screen door as claimed in claim 1, wherein said stiles and said beams are made of PVC materials, and wood chips, and additives, said wood chips include 10-60% of said frame by weight, and include a diameter of 40-100 mesh, and include a specific weight of 0.5-0.8 g/cm³.
